(19) United States
(12) Patent Application Publication
(10) Pub. No.: US 2026/0127274 A1
(43) Pub. Date: May 7, 2026

(54) CYBER-INCIDENT MANAGEMENT SYSTEM AND METHOD THEREOF

(71) Applicant: Radware Ltd., Tel Aviv (IL)

(72) Inventor: David AVIV, Tel Aviv (IL)

(73) Assignee: Radware Ltd., Tel Aviv (IL)

(21) Appl. No.: 18/934,690

(22) Filed: Nov. 1, 2024

(51) Int. Cl. G06F 21/55; G06N 20/00

(52) U.S. Cl. CPC G06F 21/554; G06N 20/00; G06F 2221/034

(57) ABSTRACT

In some implementations, the device may include instantiating a plurality of agents configured to communicate with a plurality of security tools deployed in the organization, where each of the plurality security tools defends against a different type of cyber-incident. In addition, the device may include receiving, by an agent of the plurality of agents, an input request from a respective security tool, where the input request includes at least a traffic pattern; generating, by the agent, a prompt for an AI model based on at least the input request the prompt when processed by the AI model returns at least instructions to modify at least one security policy set with the security tool; and feeding, by the agent, the at least instructions to the security tool, where the at least instructions, when executed by the security tool, causes the security tool to modify each of the least one security policy in real-time.

### TECHNICAL FIELD

The present disclosure generally relates to cybersecurity systems and, more particularly, to an incident response system.

### BACKGROUND

An Emergency Response Team (ERT) in cybersecurity is a specialized group responsible for detecting, responding to, and mitigating security incidents, such as cyber-attacks or data breaches. Their role includes monitoring networks, containing threats, conducting forensic analysis, and restoring systems to normal operations. ERTs also communicate with internal stakeholders, law enforcement, and regulatory bodies, ensuring proper incident management. They proactively work to strengthen an organization's defenses through vulnerability assessments and training, and after incidents, they analyze and report on the event to improve future response strategies. ERTs play a crucial role in minimizing damage, ensuring compliance, and enhancing organizational resilience against cyber threats.

Complex cyber-attack vectors involve sophisticated, multi-layered methods that cybercriminals use to infiltrate and compromise systems. These attacks often combine techniques like Advanced Persistent Threats (APTs), zero-day exploits, and supply chain attacks, allowing attackers to remain undetected and cause significant harm. Attackers may use fileless malware, which operates in-memory, or Man-in-the-Middle (MitM) attacks to intercept communications. Additionally, Ransomware-as-a-Service (RaaS) models have made ransomware more accessible to less skilled attackers while Living off the Land (LotL) attacks exploit legitimate tools already present within a system, making detection difficult.

These attack vectors often involve multiple stages, such as initial access via social engineering and spear phishing, followed by privilege escalation, lateral movement, and data exfiltration. Attackers may leverage large-scale Distributed Denial-of-Service (DDoS) attacks using IoT botnets or employ watering hole attacks by compromising legitimate websites frequented by the target group. Due to the complexity and stealth of these methods, organizations must adopt a multi-layered defense strategy that includes advanced threat detection, incident response plans, and continuous monitoring to mitigate these sophisticated threats.

Detecting complex cyber-attacks is difficult because attackers use advanced evasion techniques, which exploit legitimate tools and avoid traditional security measures to execute complex cyber-attack vectors. The lack of real-time monitoring, weaknesses in legacy security tools, and insufficient expertise of ERT further complicate detection efforts, making these attacks highly challenging to identify and mitigate in a timely manner.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some aspects” or “certain aspects” may be used herein to refer to a single embodiment or multiple embodiments of the disclosure.

A method of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, method may include instantiating a plurality of agents configured to communicate with a plurality of security tools deployed in the organization, where each of the plurality security tools defends against a different type of cyber-incident. Method may also include receiving, by an agent of the plurality of agents, an input request from a respective security tool, where the input request includes at least a traffic pattern; generating, by the agent, a prompt for an AI model based on at least the input request the prompt when processed by the AI model returns at least instructions to modify at least one security policy set with the security tool; and feeding, by the agent, the at least instructions to the security tool, where the at least instructions, when executed by the security tool, causes the security tool to modify each of the least one security policy in real-time. Other embodiments of this aspect include corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: instantiate a plurality of agents configured to communicate with a plurality of security tools deployed in the organization, where each of the plurality security tools defends against a different type of cyber-incident; receive, by an agent of the plurality of agents, an input request from a respective security tool, where the input request includes at least a traffic pattern generate, by the agent, a prompt for an AI model based on at least the input request the prompt when processed by the AI model returns at least instructions to modify at least one security policy set with the security tool; and feed, by the agent, the at least instructions to the security tool, where the at least instructions, when executed by the security tool, causes the security tool to modify each of the least one security policy. Other embodiments of this aspect include corresponding computer systems, apparatus, and computer programs recorded on one or more computer storage devices, each configured to perform the actions of the methods.

In one general aspect, the system may include one or more processors configured to instantiate a plurality of agents configured to communicate with a plurality of security tools deployed in the organization, where each of the plurality of security tools defends against a different type of cyber-incident. The system may furthermore include receiving, by an agent of the plurality of agents, an input request from a respective security tool, where the input request includes at least a traffic pattern. The system may in addition include generating, by the agent, a prompt for an AI model based on at least the input request the prompt when processed by the AI model returns at least instructions to modify at least one security policy set with the security tool. The system may moreover include feed, by the agent, the at least instructions to the security tool, where the at least instructions, when executed by the security tool, cause the security tool to modify each of the least one security policy in real-time. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 shows an example of a functional diagram of system according to an embodiment.

FIG. 3 shows an example block diagram of an agent according to an embodiment.

FIG. 4 is a flowchart of an example process for managing cyber-incidents according to an embodiment.

FIG. 5 is an example schematic diagram of a system according to an embodiment.

### DETAILED DESCRIPTION

The various disclosed embodiments include a method and system for managing cyber-incidents. A cyber-incident (or a cyber-attack) is an event that affects the confidentiality, integrity, or availability of information systems, networks, or data. A cyber-incident can result from malicious activities such as hacking, unauthorized access, or malware, but also from accidental or unintentional actions like human error or system failures. Cyber-incidents often involve breaches of security policies or controls and can have significant impacts on individuals, organizations, or even national security. Examples of cyber-incidents may include data breaches where sensitive data is stolen or exposed, ransomware attacks that encrypt data and demand payment for its release, vulnerabilities exploration, denial-of-service (DoS) or distributed denial-of-service (DDoS) attacks that disrupt access to a network or website, phishing attacks, and the like. Cyber-incidents can also be broadly defined as irregularity of operation, abnormal operation, and the like.

The system may instantiate a plurality of agents receiving, by each of the agents, an input request from a respective security tool. The input request includes at least a traffic pattern. The system may also generate by an agent a prompt for an AI model based on the input request. The prompt when processed by the AI model returns at least instructions to modify at least one security policy set with the security tool. The output instructions are fed to a respective security tool. Such instructions, when executed by the security tool, cause the security tool to modify or create new security policies to better detect, characterize, and/or mitigate cyber-incidents.

Some embodiments disclosed herein also include configuring agents with the AI models, where each AI model is trained with security policies and capabilities of a respective security tool. For example, if a security tool is a DDoS detection device the AI model would be trained with security policies and capabilities for detecting DDoS cyber-incidents.

The system is configured, in an embodiment, to generate or modify security policies in security tools based on inputs received from such tools. Such input includes at least peace-time or attack-time traffic. The security policies are generated or modified in real-time as traffic patterns are received from security tools and as the incidence is ongoing or active. Furthermore, operation of the disclosed system is during peace-time and attack-time, those security policies enforced by the tools can be updated or created for these two modes of operation.

It should be appreciated that modifying or creating security policies in real-time provides an improved technical solution to identify and mitigate cyber-incidents in a timely manner. It would further provide an improved technical solution to reduce the rate of false positive detection of cyber-incidents during peace-time. This would also reduce the compute resources typically allocated to process faulty detection alerts and of course would improve overall cyber security in the organization.

The lack of real-time monitoring, weaknesses in legacy security tools, and insufficient expertise of ERT further complicate detection efforts, making these attacks highly challenging to identify and mitigate in a timely manner.

In this regard, it is recognized that a human can manually modify or create policies in a security tool. However, when doing so, a human applies subjective criteria to determine what parameters and actions should be processed by the policy. Furthermore, different humans may apply different subjective criteria, resulting in even more disparity in policies. It is recognized that insufficient expertise of operators (ERT) complicates detection efforts, making these attacks highly challenging to identify and mitigate in a timely manner.

The disclosed system solves this, in an embodiment, by at least using an AI model trained on the capabilities of a specific security tool, thus generating reliable security policies for that tool.

It has further been recognized that a human cannot manually generate many security policies in real-time, and thus, manage the lifecycle of a cyber-incident at real-time as traffic is received. Since humans are incapable of doing so in real-time, where every second is crucial when dealing with cyber-incidents. While a human would be manually generating or modifying policies, a hacker may exploit a cybersecurity weakness, vulnerability, and the like, which is why speed is of the essence.

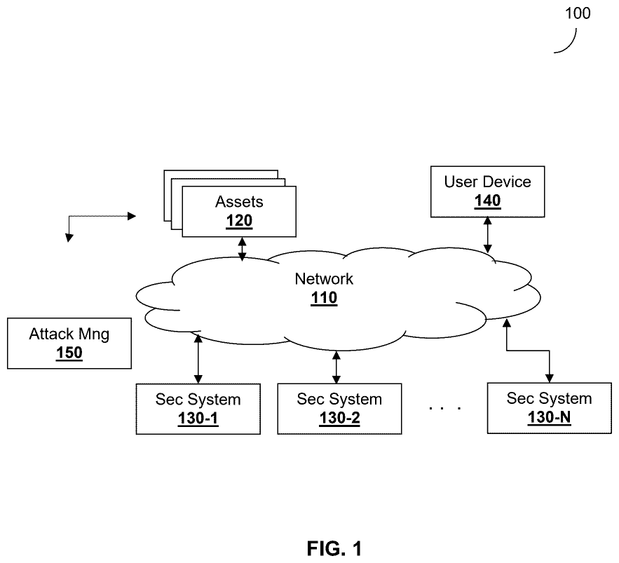

FIG. 1 shows an example network diagram 100 utilized to describe the various disclosed embodiments. In the example network diagram 100, a plurality of assets 120, a plurality of security (sec) tools 130-1 through 130-N (hereinafter referred to individually as a security tool 130 and collectively as security tools, merely for simplicity purposes), a user device 140, an AI-based cyber-incident management system 150 (or simply system 150), communicate via a network 110. Network 110 may be, but is not limited to, a wireless, cellular, or wired network, a Local Area Network (LAN), a Wide Area Network (WAN), a Metro Area Network (MAN), the Internet, the World Wide Web (WWW), similar networks, and any combination thereof. Network 110 may include or be part of a cloud computing platform, such as a public cloud, a private cloud, or a hybrid cloud.

Assets 120 may include any computing resources, physical or virtual, in an enterprise or organization, protected by the security tools 130. Assets 120 may include servers, databases, computers, network devices, virtual machines, containers, serverless, and the like. Assets 120 may be deployed on-premises or on a cloud computing platform.

Security tools 130 are used to protect systems, networks, and data from threats. These tools help with tasks such as monitoring, detecting, preventing, and responding to cyber-attacks. Examples of security tools 130 include Intrusion Detection and Prevention Systems (IDPS), Endpoint Protection and Detection (EPD), firewalls, vulnerability scanning, and management, network monitoring and analysis, DDoS detection mitigation, Data Loss Prevention (DLP), Application Programming Interface (API) security system, and the like.

Security tools 130 are equipped with automatic detection and/or mitigation capabilities. Each tool 130 is designed to handle a different type of cyber-attack. Security tools 130 may not necessarily analyze the reason for a cyber-attack, especially a complex cyber-attack vector. Not reasoning the attack may affect the ability to detect and mitigate future similar attacks as, for example, updating policies.

When attacks are not detected, or detected but not mitigated, or partially detected and/or mitigated, indicative information or signals are sent to an ERT (e.g., a user operating a user device 140). An ERT user may perform operations to investigate the indicative information to characterize the ongoing attack and decide on potential mitigation actions. The user device (UD) 140 may be but is not limited to, a personal computer, a laptop, a tablet computer, a smartphone, a wearable computing device, or any other device capable of receiving and displaying notifications.

As mentioned above, the lack of real-time monitoring, weaknesses in security tools 130, and insufficient expertise of an ERT further complicate detection efforts, making these attacks highly challenging to identify and mitigate in a timely manner. In the world of cybersecurity, an ERT may take days to investigate an ongoing attack, during which significant damage can occur.

The disclosed system 150 is an AI-based system that can provide an immediate response to indicative information received from tools 130, investigate an ongoing attack, and command and execute mitigating actions to block the attack.

System 150 can further reason a detected cyber-attack. Cyber-attack reasoning refers to the motivation, methods, and logic behind why and how cyber attackers target systems, networks, or data. Understanding the reasoning behind a cyber-attack allows one to anticipate threats, build better defenses, and effectively respond to incidents. Cyber-attack reasoning performed by system 150 allows for an update of security policies implemented by security tools 130.

System 150 may further provide a complete lifecycle management of cyber-incidents. To this end, system 150 can onboard new security tools and, specifically, their policies. That is, system 150 maintains each tool 130's full capabilities and the policies that each tool 130 is configured with. Therefore, system 150 provides a complete view of the cybersecurity capabilities in an organization where the system 150 is deployed.

In an embodiment, system 150 analyzes the policies of tools 130 and updates such policies during peace-time. The recommendation on revisions of security policies can be based on peace-time traffic patterns fed by tools 130 into system 150. In cybersecurity, a security policy is a set of rules and configurations that dictate how the tool should act to protect systems, networks, or data from threats. These policies cover areas like access control, network security, data protection, intrusion detection, and incident response. They define actions such as blocking suspicious traffic, managing user permissions, encrypting data, applying patches, and responding to breaches. Policies are essential for tailoring the tool's 130 behaviors to meet an organization's specific security needs and prevent cyberattacks. Typically, the policies are set by a user (a human operator). As such, the defined policies may not be accurate or optimized. As noted above, manually setting policies may increase the false positive rate of attacks. Therefore, modifying and refining the policies of tools 130 would reduce the false positive rate of attacks. As will be discussed below, the modification of policies is performed in real-time and during peace-time as traffic is received, processed, and monitored by tools. It should be noted the modification of such policies may occur as the respective tools are onboard to system 150.

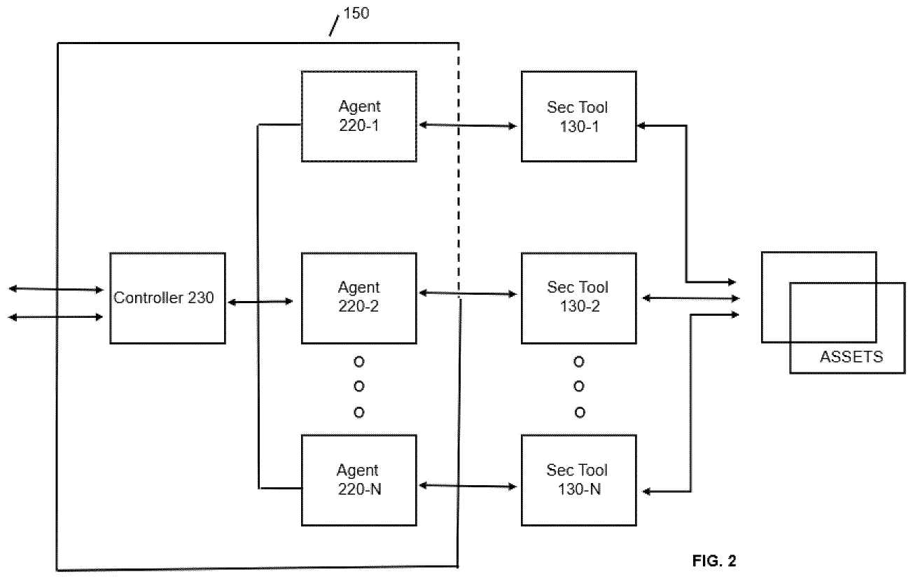

According to some embodiments discussed in detail above, system 150 may include a plurality of agents, and each agent is assigned to a security system 130. Thus, an agent may investigate, detect, or respond to a certain type of cyber-attack or incident. An agent can maintain and recommend updates for policies during runtime. The architecture of such an agent is discussed with reference to FIG. 2.

In an embodiment, system 150 may receive indicative information from a security tool 130 (e.g., a DDoS detection system), such information may be reported when system 130 cannot handle the attack. System 150 generates a prompt based on indicative information and potential metadata from external resources. The generated prompt is fed to an AI-model trained on a specification of a “corresponding” security tool 130. The output of the AI-model is a set of instructions for configuring the security tool to detect or mitigate the ongoing attack. In an embodiment, the set of instructions may include new or revised policies to be configured with the security tool 130. In an embodiment, the AI-model is a Large Language Model (LLM) trained on the security tool 130.

FIG. 2 shows an example of a functional diagram of system 150 according to an embodiment. System 150 includes a plurality of agents 220-1 through 220-n, each of which is associated with a security tool 130-1 through 130-N, respectively. A security tool 130 may detect and/or mitigate a different type of cyber-attack triggered against the protected assets 120. Security tools 130 and assets 120 are discussed above in more detail. System 150 may further include a controller 230.

An agent (e.g., agent 220-1) is configured to receive indicative information on a potential or ongoing cyber-attack from a security tool (e.g., tool 130-1). Agent 220-1 generates a prompt based on at least the indicative information and feeds the generated prompt to an AI-model to provide a response to tool 130-1 on how to respond to the potential attack. In an embodiment, agent 220-1 returns to the tool 130-1 instructions on detecting or blocking the attack. For example, tool 130-1 may be a DDoS detection tool, and the indicative information may include telemetric data collected by tool 130. Such data may include a source IP address of a suspicious machine, suspicious traffic patterns, granular data on network flows, and the like. Agent 220-1 may send instructions to tool 130-1 to change to detection thresholds at tool 130-1. The instructions may be in a format for JSON, a script, or other type configuration files. The AI-model embedded in each agent 220-1 is trained with the specification of, for example, a DDoS detection tool.

The prompt may be generated using metadata retrieved from one or more external sources. For example, agent 220-1 can request such data from external sources (not shown) through controller 230. For example, external data sources may include reputation services, threat analysis reports, vulnerability databases, and the like. Controller 230 may include LLM metadata that may be received by querying controller 230.

Controller 230 may also provide an interface to a user (via user device 140), allowing the user to feed prompts to system 150 using a natural language. For example, a user submits queries related to the attack reasoning. Such questions may include: what happened, when it happened, and why it happened. Of course, any prompt that can be answered by agent 220 can be input to system 150.

Further, controller 230 can receive feedback from multiple more agents 220 participated in detecting and/or mitigating attacks. Controller 230 may cross-correlate such feedback to identify attack vectors that involve multiple stages. Each stage of such an attack vector may be identified by an individual agent 220, while controller 230 analyzes the sequence of the attack and instructs agent 220 on how to handle the attack vectors. Agent 220, when instructed by controller 230, may generate and send instructions to its respective tool 130-1.

The disclosed system 150 provides an ongoing incident response by allowing the continuous process of managing, mitigating, and resolving incidents (attacks) while such incidents are actively occurring. System 150 involves real-time actions to control and minimize the damage caused by the incidents, gather information about the attack from tools 130, and implement immediate remediation efforts by agent 220. During ongoing incident response, system 150 continuously and automatically operates to contain the threat and ensure the organization's assets 120 are protected.

It should be understood that the operations of system 150 described herein cannot be performed using the human mind or by performing the operation using paper and pencil. Moreover, a human operator applies subjective criteria to select/simulate/predict, leading to results that are not consistent between different human operators and often not consistent between the same human performing the same task repeatedly, and in particular at the speeds required to provide an operable solution. The number of possible permutations for analyzed threats, security processes, policies, and parameter value selection far exceeds any practical use of the human mind. Thus, implementing the teachings discussed herein by System 150 allows for better security and faster response to cyber incidents.

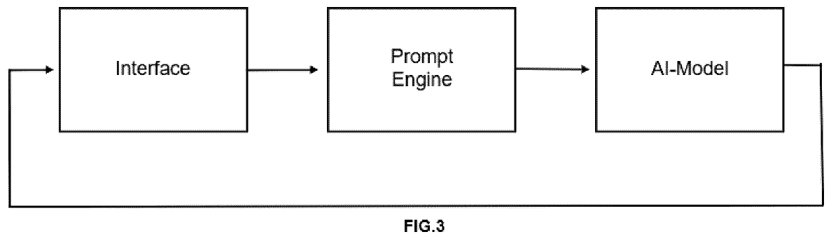

FIG. 3 shows an example block diagram of an agent 220 according to an embodiment. Agent 220 includes an interface 310, a prompt generator 320, and an AI model 330. Interface 310 interfaces between a security tool (130) and an agent 220 to receive indicative information on a potential attack and to send configuration instructions to the respective tool. Interface 310 can also interface with the controller (230, FIG. 2) to receive metadata and queries. Interface 310 may be realized as an API.

Prompt generator 320 receives indicative information from a security tool and optionally metadata from agent 220. Prompts are generated to address a specific function or tool 130 based on the indicative information. Metadata may include information that can accurately answer the prompt. Metadata can be retrieved from external sources or by querying controller 230, examples for which are provided above.

AI model 330 receives the prompt generated by prompt generator 320 and is configured to train a model to provide instructions to configure a respective security tool. In an embodiment, AI-model 330 is an LLM trained on the specification of the respective security tool. For example, AI-model 330 can be realized as GPT (such as GPT-4), BERT (Bidirectional Encoder Representations from Transformers), T5 (Text-to-Text Transfer Transformer-Google), LaMDA (Language Model for Dialogue Applications), Megatron-Turing NLG (MT-NLG), XLNet, Grok, Claude (by Anthropic), Bloom (BigScience), OPT (Open Pretrained Transformer), and the like.

As an example, indicative information may include an attack pattern (or signature) and an applied policy. The prompt would be “Generate a new security policy to block an attack having the following pattern when the following policy was not operational”. AI-model 330 will generate a new policy based on the prompt received, with instructions on how to configure the security tool 130.

In an embodiment, feedback can be provided from the tool as to whether the attack was blocked using the new policy and if the AI-model 330 can be trained to include the new policy. Otherwise, a recently generated policy is revised.

In an embodiment, agent 220 can provide recommendations on how to improve security policies and security tools. To this end, the AI-model 330 may be trained or configured with initial security policies set for the tools. During peace-time, through interface 310, traffic patterns (or other signals) monitored by the security tools are received at the prompt generator 320. Prompts are generated to modify the policies set with the security tools 130 based on the peace-time traffic patterns. AI model 330 receives the prompt generated by prompt generator 320 and is configured to provide, based on the prompt, a set of instructions to modify the policies with the security tool(s).

In an embodiment, agent 220 can implement a RAG (Retrieval-Augmented Generation) process. A RAG process is an advanced AI framework that enhances the process of generating responses by combining two main components: retrieval and generation. Operating the RAG process is useful when the AI model does not store all the capabilities and policies of the security tools.

In an embodiment, when implementing an RAG process, agent 220 first retrieves information about the capabilities of the security tools. This may include semantically searching relevant documents stored in the organization's repositories, vendors of the security tools, publicly available databases, and the like. The retrieval process is designed to provide the model with the most relevant and high-quality information based on the input prompt.

At the augmentation stage, the prompt is enriched. This may involve summarizing the retrieved information, combining different data points, or using them as context for generating a final response. According to an embodiment, during the augmentation stage, prompts can be augmented with the respective capabilities of the tools as retrieved and attack indicative information (on potential attack). Alternatively or collectively, during the augmentation stage, prompts can be augmented with the respective security policies and runtime information.

At the Generation stage, AI model 330 then processes the query and the retrieved data to generate a coherent and contextually accurate response. That response being: instructions to modify security policies, instructions to change parameters for better detection, or mitigation of a cyber-attack. It should be noted that the generation phase is not solely based on the training data of the model itself but also integrates the external information retrieved, which increases the factual accuracy and relevance of the output.

It should be noted that utilizing the RAG process reduces the need to fine-tune the AI model, which significantly saves on compute resources.

It should be noted that agents 220 and their components may be realized in software, firmware, hardware, or a combination thereof. In one configuration, software for implementing one or more embodiments disclosed herein may be stored in the memory or storage and processed by a processor. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

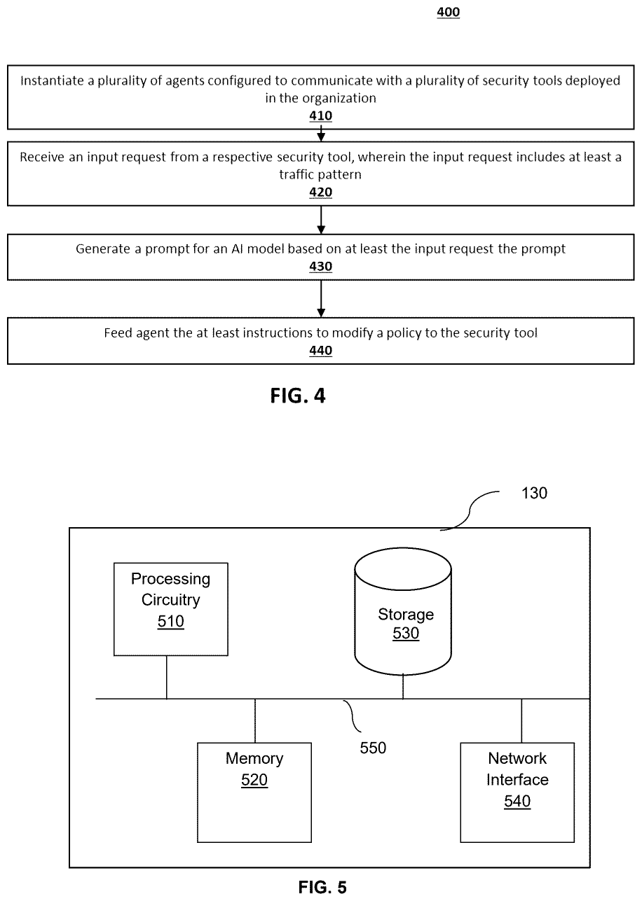

FIG. 4 is a flowchart of an example process 400 for managing cyber-incidents according to an embodiment. In some implementations, one or more process blocks of FIG. 4 may be performed by a system, such as system 150 (FIG. 1).

As shown in FIG. 4, process 400 may include instantiating a plurality of agents configured to communicate with a plurality of security tools deployed in the organization. In an embodiment, each of the plurality security tools defends against a different type of cyber-incident. Examples of security tools are discussed above (S410).

At S420, each agent may receive an input request from a respective security tool. In an embodiment, the input request includes at least a traffic pattern. The traffic pattern may include rate-based traffic parameters, rate-invariant parameters, a communication protocol type (e.g., HTTP, HTTPs, TCP/IP, UDP, and the like), and a baseline, and the like. Rate-invariant traffic parameters are network metrics that remain consistent regardless of the traffic transmission rate. Key examples include packet loss (percentage of lost packets during transmission); latency (time taken for a packet to travel from source to destination); jitter (variation in packet arrival times); throughput efficiency (proportion of network capacity effectively used for successful data transmission); error rate (frequency of transmission errors, like bit or packet errors), and the like. Rate-based traffic parameters are metrics that depend on the volume or speed of data transmission in a network. Key examples include: bandwidth utilization (the percentage of the network's capacity being used); throughput (the rate of successful data transmission, measured in bits per second); traffic load (the volume of traffic on the network, in packets or bits per second); data transfer rate (the speed of data transmission between devices); packet arrival rate (the number of packets arriving per second), and the like. The baseline may be computed based on peace-time traffic. The input request may also include attributes representing attacker's activity, such as, but not limited to attributes representing attacker's activity including at least one of the logs, file changes, process behavior, and operating system events.

In one embodiment, the traffic pattern demonstrates an ongoing cyber-incidents, and where the input request further includes an attack-time request. The attack-time request further includes at least one of: a request to improve detection of the ongoing cyber-incident, a request to characterize the ongoing cyber-incident, and a request to improve mitigation of the ongoing cyber-incident. That, the attack-time request would cause modifying one or more polices related to improving detection, mitigation, and/or characterization by the respective security tool.

In another embodiment, alone or in combination with other embodiments, the traffic pattern demonstrates peace-time traffic, and where the input request further includes a peace-time request. The peace-time request further includes a request to modify an initial security and/or a request to create a new security policy with the respective security tool.

At S430, a prompt is generated for an AI model based on at least the input request. The prompt when processed by the AI model returns at least instructions to modify at least one security policy set with the security tool. In an embodiment, such instructions may include definition of a new security policy. It should be noted that a prompt is generated by an agent and sent to the agent's AI model trained based on data of the respective security tool. In one implementation, the prompt can be generated using a RAG process.

Prompts can be generated differently for peace-time and attack-time requests. That is, for an attack-time request, S430 includes generating the prompt further based on a predefined template, the traffic pattern demonstrating the ongoing cyber-incident, the attack-time request, and metadata retrieved from external sources. An example for metadata is provided below. Alternatively, S430 includes generating the prompt further based on a predefined template, the traffic pattern demonstrating peace-time traffic, the peace-time request, and metadata retrieved from external databases. The predefined template may define a set of commands to the AI-model. As an example, modify a DDoS detection policy for a device <<Device Name>> based on <<input pattern>> and <<Metadata>>. The Device Name, Input Pattern, and Metadata are input to the system.

At S440, the instructions generated by the AI model are fed to the security tool. The instructions, when executed by the security tool, cause the security tool to modify or create new security policies. In an embodiment, such instructions may cause changing in the configurations or settings of the security tools. It is important to note that modifications to security policies may occur in real-time while the incident is ongoing. Consequently, even if attackers gain an advantage in exploiting the defenses provided by security tools, the attackers cannot sustain the attack for long due to the capability to adjust security policies in real-time. Following are a few examples for modifying the policies:
To better detect a DDoS attack, a policy change may involve adjusting the detection thresholds for suspicious traffic patterns or the number of packets received from a specific source IP address.
Access Rules: Firewalls use policies to define rules for network traffic, specifying which connections are permitted or denied based on criteria like source and destination IP addresses, ports, and protocols. The disclosed system can generate instructions to modify these rules to block traffic from newly identified malicious sources or restrict access to sensitive systems based on observed attack patterns.
Content Filtering: Data Loss Prevention (DLP) security systems use policies to prevent sensitive data from leaving the organization's network. These policies can be modified to include new patterns or keywords related to the attack, thereby preventing the exfiltration of sensitive data.
Intrusion Prevention Rules: Intrusion Detection and Prevention Systems (IDPS) use rules to identify and block malicious activity. The disclosed system may generate instructions to add new rules based on the attack signature or modify existing rules to improve detection and prevention.

Process 400 may further include instantiating a controller agent to communicate with the plurality of agents. This would allow a user to submit attack reasoning queries. Such queries can be natural language queries. Examples of such queries are provided below. Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

FIG. 5 is an example schematic diagram of a system 150 according to an embodiment. The system 150 includes a processing circuitry 510 coupled to a memory 520, a storage 530, and a network interface 540. In an embodiment, the components of the system 150 may be communicatively connected via a bus 550.

The processing circuitry 510 may be realized as one or more hardware logic components and circuits. For example, and without limitation, illustrative types of hardware logic components that can be used include Field Programmable Gate Arrays (FPGAs), Application-Specific Integrated Circuits (ASICs), Application-Specific Standard Products (ASSPs), System-On-a-Chip systems (SOCs), Graphics Processing Units (GPUs), Tensor Processing Units (TPUs), general-purpose microprocessors, microcontrollers, Digital Signal Processors (DSPs), specialized AI chips for real-time inference, and the like, or any other hardware logic components that can perform calculations or other manipulations of information.

The memory 520 may be volatile (e.g., random access memory, etc.), non-volatile (e.g., read-only memory, flash memory, etc.), large memory (HBM), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, and fast storage (NVMe), or any other medium which can be used to store the desired information.

The network interface 540 allows the system 150 to communicate with other systems, devices, components, applications, or other hardware or software components, for example as described herein.

It should be understood that the embodiments described herein are not limited to the specific architecture illustrated in FIG. 5, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for managing cyber-incidents lifecycle of cyber-attacks, comprising:
instantiating a plurality of agents configured to communicate with a plurality of security tools deployed in an organization, wherein each of the plurality security tools defends against a different type of cyber-incident;
receiving, by an agent of the plurality of agents, an input request from a respective security tool, wherein the input request includes at least a traffic pattern;
generating, by the agent, a prompt for an AI model based on at least the input request the prompt when processed by the AI model returns at least instructions to modify at least one security policy set with the security tool; and
feeding, by the agent, the at least instructions to the security tool, wherein the at least instructions, when executed by the security tool, causes the security tool to modify each of the least one security policy in real-time.

2. The method of claim 1, further comprising:
configuring the agent with the AI model; and
training the AI model with security policies and capabilities of the respective security tool.

3. The method of claim 2, wherein the traffic pattern demonstrates an ongoing cyber-incident, and wherein the input request further includes an attack-time request.

4. The method of claim 3, wherein the attack-time request further includes at least one of: a request to improve detection of the ongoing cyber-incident, a request to characterize the ongoing cyber-incident, and a request to improve mitigation of the ongoing cyber-incident.

5. The method of claim 3, wherein generating the prompt further comprising:
generating the prompt further based on a predefined template, the traffic pattern demonstrating the ongoing cyber-incident, the attack-time request, and metadata retrieved from external databases.

6. The method of claim 1, wherein the traffic pattern demonstrates peace-time traffic, and wherein the input request further includes a peace-time request.

7. The method of claim 3, wherein a peace-time request further includes: at least one of: a request to modify an initial security, and a request to create a new security policy.

8. The method of claim 6, wherein generating the prompt further comprises:
generating the prompt further based on a predefined template, the traffic pattern demonstrating peace-time traffic, the peace-time request, and metadata retrieved from external databases.

9. The method of claim 1, further comprising:
instantiating a controller agent to communicate with the plurality of agents; and
responding, by the controller agent, to attack reasoning queries submitted by a user.

10. The method of claim 9, wherein the queries are natural language queries.

11. The method of claim 1, further comprising:
configuring each agent with the AI model; and
using a retrieval-augmented generation (RAG) process to generate the prompts.

12. The method of claim 1, wherein the security tools is any one of: an intrusion detection and prevention system (IDPS), an endpoint protection and detection (EPD) system, a firewall, a vulnerability scanning and management system, a network monitoring and analysis system, a DDoS detection mitigation system, a data loss prevention (DLP) system, and an API security system.

13. The method of claim 1, wherein a traffic pattern in the input request includes at least any one of: rate-based traffic parameters, rate-invariant parameters, a communication protocol type, a baseline, and attributes representing attacker's activity.

14. The method of claim 13, wherein the attributes representing attacker's activity include at least one of the logs, file changes, process behavior, and operating system events.

15. A non-transitory computer-readable medium storing a set of instructions for managing cyber-incidents lifecycle of cyber-attacks, the set of instructions comprising:
one or more instructions that, when executed by one or more processors of a device, cause the device to:
instantiate a plurality of agents configured to communicate with a plurality of security tools deployed in an organization, wherein each of the plurality security tools defends against a different type of cyber-incident;
receive, by an agent of the plurality of agents, an input request from a respective security tool, wherein the input request includes at least a traffic pattern
generate, by the agent, a prompt for an AI model based on at least the input request the prompt when processed by the AI model returns at least instructions to modify at least one security policy set with the security tool; and
feed, by the agent, the at least instructions to the security tool, wherein the at least instructions, when executed by the security tool, causes the security tool to modify each of the least one security policy in real-time.

16. A system for managing cyber-incidents lifecycle of cyber-attacks comprising:
one or more processors configured to:
instantiate a plurality of agents configured to communicate with a plurality of security tools deployed in an organization, wherein each of the plurality security tools defends against a different type of cyber-incident;
receive, by an agent of the plurality of agents, an input request from a respective security tool, wherein the input request includes at least a traffic pattern
generate, by the agent, a prompt for an AI model based on at least the input request the prompt when processed by the AI model returns at least instructions to modify at least one security policy set with the security tool; and
feed, by the agent, the at least instructions to the security tool, wherein the at least instructions, when executed by the security tool, causes the security tool to modify each of the least one security policy in real-time.

17. The system of claim 16, wherein the one or more processors are further configured to:
configure the agent with the AI model; and
train the AI model with security policies and capabilities of the respective security tool.

18. The system of claim 17, wherein the traffic pattern demonstrates an ongoing cyber-incident, and the input request further includes an attack-time request.

19. The system of claim 18, wherein the attack-time request further includes at least one of:
a request to improve detection of the ongoing cyber-incident, a request to characterize the ongoing cyber-incident, and a request to improve mitigation of the ongoing cyber-incident.

20. The system of claim 18, wherein the one or more processors, when generating the prompt, are configured to:
generate the prompt further based on a predefined template, the traffic pattern demonstrating the ongoing cyber-incident, the attack-time request, and metadata retrieved from external databases.

21. The system of claim 18, wherein a peace-time request further includes:
a request to modify an initial security, and a request to create a new security policy.

22. The system of claim 16, wherein the traffic pattern demonstrates peace-time traffic, and the input request further includes a peace-time request.

23. The system of claim 22, wherein the one or more processors, when generating the prompt, are configured to:
generate the prompt further based on a predefined template, the traffic pattern demonstrating peace-time traffic, the peace-time request, and metadata retrieved from external databases.

24. The system of claim 16, wherein the one or more processors are further configured to:
instantiate a controller agent to communicate with the plurality of agents; and
respond, by the controller agent, to attack reason queries submitted by a user.

25. The system of claim 24, wherein the queries are natural language queries.

26. The system of claim 16, wherein the one or more processors are further configured to:
configure each agent with the AI model; and
use a retrieval-augmented generation (RAG) process to generate the prompts.

27. The system of claim 16, wherein the security tools is any one of:
an intrusion detection and prevention system (IDPS), an endpoint protection and detection (EPD) system, a firewall, a vulnerability scanning and management system, a network monitoring and analysis system, a DDoS detection mitigation system, a data loss prevention (DLP) system, and an API security system.

28. The system of claim 16, wherein a traffic pattern in the input request includes at least any one of:
rate-based traffic parameters, rate-invariant parameters, a communication protocol type, a baseline, and attributes representing attacker's activity.

29. The system of claim 28, wherein the attributes representing attacker's activity include at least one of the logs, file changes, process behavior, and operating system events.
